(19) United States
(12) Patent Application Publication
(10) Pub. No.: US 2018/0089627 A1
(43) Pub. Date: Mar. 29, 2018

(54) SYSTEM AND METHOD FOR ADVANCED CANDIDATE SCREENING

(71) Applicant: American Express Travel Related Services Company, Inc., New York, NY (US)

(72) Inventor: Gregory Liss, Litchfield Park, AZ (US)

(73) Assignee: American Express Travel Related Services Company, Inc., New York, NY (US)

(21) Appl. No.: 15/280,496

(22) Filed: Sep. 29, 2016

(51) Int. Cl. G06Q 10/10; G06F 17/30

(52) U.S. Cl. CPC G06Q 10/1053; G06F 17/30864

(57) ABSTRACT

A system and method for advanced candidate screening is provided. The system may receive a candidate resume comprising candidate identifying information and candidate skills. The system may retrieve defined skills and generated a parsed skill by parsing the candidate resume to determine the candidate skills matching the defined skills. The system may retrieve skill questions corresponding to the parsed skills and generate a candidate assessment document comprising the skill questions corresponding to the parsed skills. The system may transmit the candidate assessment document for candidate completion, and receive a completed candidate assessment document. The system may score the completed candidate assessment document, and store the scored candidate resume for later candidate requests and screening.

### FIELD

The disclosure generally relates to job screening, and more specifically, to systems and methods for advanced candidate screening.

### BACKGROUND

Interviewing and screening candidates for a job opening may have many difficulties. Typically, the process of interviewing and screening candidates may be cumbersome, expensive, and time consuming. For example, job openings requiring technical expertise (e.g., engineering, science, and/or the like) may require an interviewer having a similar technical background in order to technically assess the candidate. Prior interview techniques have involved using a team of technical experts to complete an assessment of a candidate for a specific job opening. However, the technical expert may only interview the candidate by asking questions aligned to the specific job opening. Using a different technical expert for each candidate interview may also create consistency problems such as each technical expert screening and interviewing candidates using different methods, questions, and techniques.

Timing may also create problems for interviewing and screening candidates. For example, there is often a delay between the posting of a job opening and the submission of resumes from qualified candidates. Difficulties may also arise when a job opening is posted that may require immediate hiring, but qualified candidates are unable to find the job opening or are only able to locate the job opening weeks or months after the initial job posting. Similarly, a candidate may apply for a job opening but may be better suited and qualified for a separate job opening. As such, there is an increased need for systems and methods to provide advanced candidate screening allowing for the automated assessment and identification of candidates consistently, efficiently, and based on the skills of the candidate, regardless of the job originally applied for.

### SUMMARY

Systems, methods, and articles of manufacture (collectively, the “system”) for advanced candidate screening are disclosed. In various embodiments, the system may receive a candidate resume. The candidate resume may comprise candidate identifying information and candidate skills. The system may retrieve defined skills from a skills library. The system may determine a parsed skill by parsing the candidate resume to locate the candidate skills matching the defined skills. The system may retrieve skill questions corresponding to the parsed skills. The skill questions may be retrieved from a skill questions database. The system may generate a candidate assessment document. The candidate assessment document may comprise the candidate identifying information and the skill questions corresponding to the parsed skills.

In various embodiments, the system may also receive a completed candidate assessment document. The completed candidate assessment document may comprise candidate answers to the candidate assessment document. In various embodiments, the system may also retrieve skill answers corresponding to the skill questions. The skill answers may be retrieved from the skill questions database. The system may formulate a candidate score by comparing the candidate answers to the skill answer. The system may generate a scored candidate resume. The scored candidate resume may comprise the candidate identifying information, the parsed skills, and the candidate score. In various embodiments, the system may receive a candidate request. The candidate request may comprise requested skills and a requested skill score. The system may match the candidate request to a scored candidate resume by comparing the requested skills to the parsed skills, and the requested skill score to the candidate score. The system may generate a matched candidate request list comprising the scored candidate resumes matched with the candidate request.

In various embodiments, the skill questions may further comprise a difficulty level. The system may retrieve the skill question having varying difficulty levels. In various embodiments, the candidate resume may be received in response to web crawling on the internet.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 is a block diagram illustrating various system components of a system for advanced candidate screening, in accordance with various embodiments;

FIG. 2 illustrates a process flow for generating a candidate assessment document, in accordance with various embodiments;

FIG. 3 illustrates a process flow for scoring a candidate assessment document, in accordance with various embodiments; and

FIG. 4 illustrates a process flow for matching a candidate request with a screened candidate, in accordance with various embodiments.

### DETAILED DESCRIPTION

The detailed description of exemplary embodiments herein makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

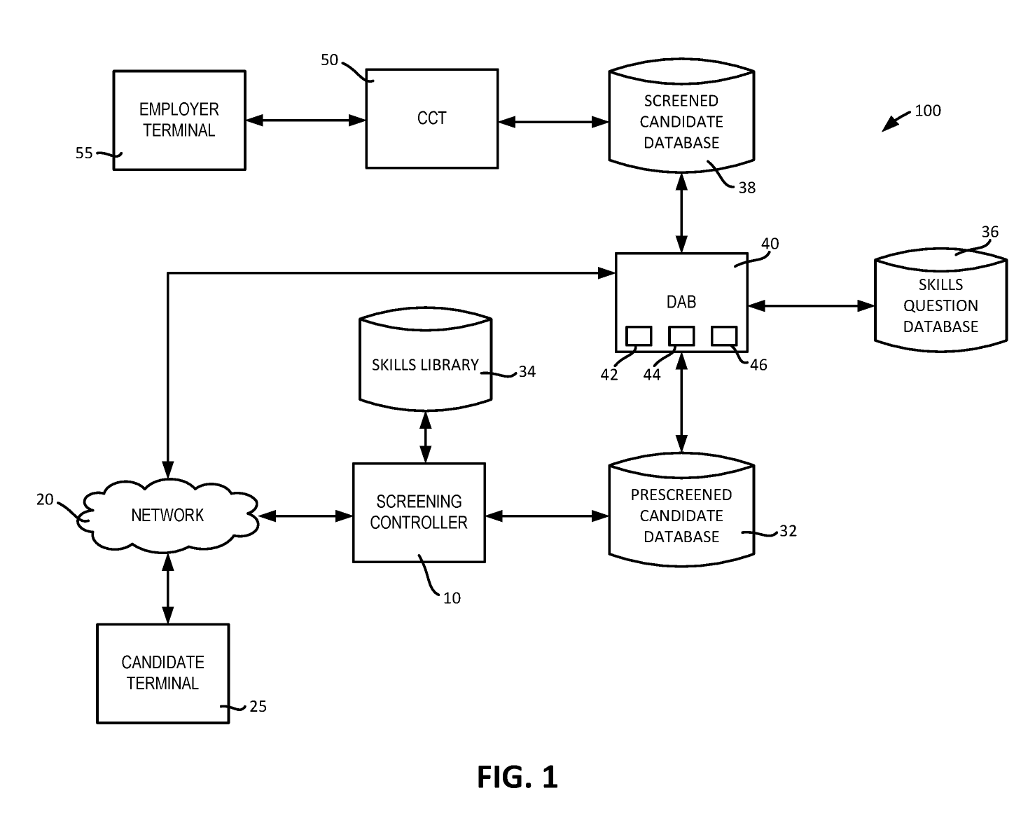

In various embodiments, and with reference to FIG. 1, a system 100 for advanced candidate screening is provided. In various embodiments, system 100 may comprise a screening controller 10. Screening controller 10 may be configured as a central hub to receive and process candidate resumes. In that regard, screening controller 10 may comprise a computer-based system, a processor, and/or any other suitable device capable of receiving, parsing, and transmitting data. Screening controller 10 may be in communication with a network 20, a skills library 34, and/or a prescreened candidate database 32. Screening controller 10 may be configured to receive a candidate resume from network 20. The candidate resume may comprise various data concerning the candidate, such as, candidate identifying information (e.g., name, address, phone number, and/or the like), candidate skills (e.g., technical proficiencies, work history, background, schooling, and/or the like), and/or any other suitable candidate information.

In various embodiments, screening controller 10 may receive the candidate resume from candidate terminal 25, via network 20. Candidate terminal 25 may comprise hardware and/or software capable of allowing a candidate access to system 100. For example, candidate terminal 25 may comprise any suitable device allowing the candidate to communicate with network 20, such as a personal computer, personal digital assistant, cellular phone, kiosk, and/or the like. Candidate terminal 25 may allow the candidate to communicate with screening controller 10 to transmit the candidate resume. In various embodiments, the candidate resume may be transmitted in any suitable format, such as, for example, a word document, PDF, and/or via a Tillable website providing pre-established fields.

In various embodiments, screening controller 10 may also dynamically receive the candidate resume from network 20. For instance, screening controller 10 may communicate with network 20 using web crawlers, and/or the like, to retrieve candidate resumes. For example, and in various embodiments, network 20 may comprise the internet, enabling screening controller 10 to reach resources and websites outside of system 100. For example, screening controller 10 may search LinkedIn.com®, Monster.com®, Indeed.com®, and/or through similar such job posting websites, via network 20, to retrieve candidate resumes. In various embodiments, screening controller 10 may dynamically search for candidate resumes based on defined skills, as discussed further below. In that respect, screening controller 10 may use a web crawler to retrieve candidate resumes corresponding to a particular subset of defined skills (e.g., screening controller 10 may search LinkedIn.com® to find candidate resumes comprising defined skills such as: “Hadoop”, “HTML”, and “Java Coding”). In various embodiments, the web crawler may search candidate resumes to at least partially match the defined skills with key words in the candidate resume (and/or online profile). In that regard, the resume information matching the defined skill does not need to be organized into pre-established fields in order to be located by screening controller 10, via the web crawler.

In various embodiments, screening controller 10 may also be in communication with skills library 34 to retrieve defined skills. The defined skills may comprise any type of skills desired in a candidate. For example, in technical fields, the defined skills may comprise technical areas such as, “Algorithms and Design”, “CSS”, “Data Modeling”, “General Database”, “Hadoop”, “HTML”, “Java Coding”, “Javascript”, “Mainframe DB2”, and/or any other suitable and/or desired field. The defined skills may also comprise broader skills, such as, for example, “Programming”, “Web Design”, and/or the like; non-technical skills such as “Agile Experience”, “Project Management”, and/or the like; and/or any other suitable skill type. In that respect, skills library 34 may store the defined skills in any suitable and/or desired format. For example, skills library 34 may store the defined skills in a hierarchical format (e.g., the defined skills of “Java Coding” and “C# Coding” may be stored under “Computer Programming Languages”, whereas the defined skills of “HTML” and “CSS” may be stored under “Web Design”, and/or the like). Skills library 34 may also store the defined skills in a list format, such as in alphabetical order and/or in any other suitable ordering.

In various embodiments, screening controller 10 may also be configured to generate a prescreened candidate resume. The prescreened candidate resume may comprise a parsed version of the candidate resume, indicating the identified skills listed and/or discussed in the resume. The system may indicate the identified skills by highlighting or otherwise noting (e.g., bold, underline, blinking, pointers, etc.) certain portions of the resume describing the skills. In that regard, screening controller 10 may parse the candidate resume to locate the defined skills disclosed in the candidate resume. For example, in response to the candidate listing “Java coding experience”, “Java coding education”, “Advanced Java Class”, and/or the like, screening controller 10 may recognize “Java” as a skill from the defined skills. Screening controller 10 may then generate the prescreened candidate resume having a parsed skill of “Java” and/or “Programming”. In that respect, and in various embodiments, screening controller 10 may generate the prescreened candidate resume to comprise metadata, tags, and/or the like indicating the parsed skills comprised in the candidate resume. For example, the prescreened candidate resume may be generated to comprise metadata indicating the parsed skill of “Java”, and/or the parsed skill of “Programming”.

In various embodiments, screening controller 10 may transmit the prescreened candidate resume to prescreened candidate database 32. Prescreened candidate database 32 may comprise any suitable system, database, and/or the like capable of receiving and storing data. Prescreened candidate database 32 may store the prescreened candidate resume in any desired and/or suitable format, such as, for example, in alphabetical order.

In various embodiments, system 100 may also comprise a dynamic assessment builder (“DAB”) 40. DAB 40 may comprise a computer-based system, processor, and/or any other suitable device capable of retrieving, parsing, and transmitting data. DAB 40 may be in communication with network 20, prescreened candidate database 32, a skills question database 36, and/or a screened candidate database 38.

In various embodiments, DAB 40 may be configured to uniquely tailor a candidate assessment document for individual candidates. In that regard, and in various embodiments, DAB 40 may comprise an assessment module 42 configured to generate a candidate assessment document. Assessment module 42 may be configured to communicate with prescreened candidate database 32 to retrieve the prescreened candidate resume from prescreened candidate database 32. Assessment module 42 may communicate with skills question database 36 to retrieve skill questions corresponding to the parsed skill associated with the prescreened candidate resume. Skills question database 36 may comprise any suitable system, database, and/or the like capable of receiving and storing data. Skills question database 36 may also store the skills questions using any suitable technique and formatting, such as, for example, grouped by the corresponding defined skill.

In various embodiments, each skill question may be associated (via metadata, tags, and/or the like) with a defined skill, a difficulty level, and a skill answer. In that respect, skills question database 36 may store skill questions having any suitable range of difficulty levels. For example, the skill questions may comprise difficulty levels of “easy”, “medium”, and “hard”; “100”, “200”, “300”, “400”, and “500”; and/or any other suitable range. As a further example, a skill question corresponding to the defined skill of “Java Coding” and having an “easy” difficulty may comprise: “Explain the object oriented concept of encapsulation,” and the skill answer corresponding to that skill question may comprise: “Encapsulation is the selective hiding of properties and methods in an object by building an impenetrable wall to protect the code from accidental corruption.” In various embodiments, the skill questions may be input into skills question database 36 via user input, retrieval from a networked resource such as the internet, and/or through any other suitable method. The skill questions may be associated with the defined skill, the difficulty level, and the skill answer prior to input into skills question database 36. For example, a user may review the skill questions and assign the difficulty level to the skill question.

In various embodiments, assessment module 42 may generate the candidate assessment document to comprise the candidate identifying information from the prescreened candidate resume, at least one skill question corresponding to each parsed skill, and/or any other suitable data and information. In various embodiments, the candidate assessment document may comprise a randomly selected set of skill questions corresponding to each parsed skill, comprising skill questions across multiple difficulty levels (e.g., two skill question from “easy”; three skill questions from “medium”; and two skill questions from “hard” difficulty levels).

In various embodiments, DAB 40 may also be configured to transmit the candidate assessment document and receive a completed candidate assessment document. In that regard, and in various embodiments, DAB 40 may comprise an interviewing module 44. Interviewing module 44 may communicate with network 20 to transmit and receive data. Interviewing module 44 may transmit the candidate assessment document to network 20. For example, the candidate assessment document may be transmitted, via network 20, to candidate terminal 25 in response to an interview request for the candidate. Interviewing module 44 may also receive a completed candidate assessment document from network 20. The completed candidate assessment document may comprise the candidate's completed answers to the skill questions from the candidate assessment document. For example, the candidate assessment document may be completed on candidate terminal 25 and transferred, via network 20, to interviewing module 44.

In various embodiments, DAB 40 may also be configured to score the completed assessment document. In that regard, and in various embodiments, DAB 40 may comprise a scoring module 46. Scoring module 46 may communicate with skills question database 36 to retrieve the skill answer corresponding to each skill question from the completed candidate assessment document. Scoring module 46 may parse the completed candidate assessment document, based on the skill answer, to determine a candidate score for each skill question, across each difficulty level. In that regard, scoring module 46 may compare the candidate answer to the skill answer to determine the level of correctness in the answer. For example, and in various embodiments, scoring module 46 may parse the candidate answer to look for keywords in the skill answer. For example, in the above example of a skill question comprising: “Explain the object oriented concept of encapsulation,” scoring module 46 may parse the candidate answer to look for keywords such as “selective hiding”, “properties”, “methods”, “object”, “wall”, “protect code”, and/or other similar keywords. In various embodiments, in response to the skill question requesting the candidate to draft programming code (e.g., in Java, C#, etc.), scoring module 46 may determine the candidate score by compiling the code, and parsing the compiled code to determine the accuracy of the compiled code. In various embodiments, the skill answer correlated to the programming skill question may comprise test cases (e.g., a plurality of code example answers to the skill question), and scoring module 46 may determine the candidate score by parsing the candidate answer to look for keywords from the test cases in the skill answers.

In various embodiments, the score may comprise a point value, such as 0, 1, 2, 3, 4, or 5 (wherein 0 is low and 5 is high), a standard grade lettering system, such as A, B, C, D, and F, and/or the like, indicating the level of correctness of the candidate answer. Scoring module 46 may score each skill question across each difficulty level, and compile and average the scores for each difficulty level. Scoring module 46 may then generate a candidate score for each defined skill, across each difficulty level. For example, a candidate score for the defined skill of “Java Coding” may comprise a “3.5” for “easy” (averaged scores of “3” and “4”), a “4.0” for “medium” (averaging scores of “3”, “4”, and “5”), and a “2.5” for “hard” difficulty levels (averaging scores of “2” and “3”). Scoring module 46 may generate a scored candidate resume comprising the candidate identifying information, the parsed skills, and the candidate score corresponding to each parsed skill.

In various embodiments, scoring module 46 may also be configured to transmit the scored candidate resume to screened candidate database 38 for storage. Screened candidate database 48 may comprise any suitable system, database, and/or the like capable of receiving and storing data. Screened candidate database 48 may also store the scored candidate resumes using any suitable technique and formatting.

In various embodiments, system 100 may also comprise a candidate capabilities tool (“CCT”) 50 configured as a central hub for retrieving scored candidate resumes. In that regard, CCT 50 may enable a user to identify a candidate that is qualified (based on a requested skill score, as discussed further below) for a job opening, without requiring the user to subject the candidate to a second interview, and regardless of whether the candidate initially applied for that job opening. CCT 50 may be in communication with screened candidate database 38 and/or an employer terminal 55.

In various embodiments, CCT 50 may be configured to receive a candidate request. The candidate request may be received from any suitable source, such as, for example, employer terminal 55. Employer terminal 55 may comprise hardware and/or software capable of allowing a user, employer, recruiter, and/or the like (hereinafter, “user”) access to system 100. For example, employer terminal 55 may comprise any suitable device allowing the user to communicate with CCT 50, such as a personal computer, personal digital assistant, cellular phone, kiosk, and/or the like. Employer terminal 55 may allow the user to communicate with CCT 50 to transmit the candidate request, and receive a matched candidate request list (as discussed in further detail below).

In various embodiments, the candidate request may comprise a requested skill, a requested skill difficulty level, and a corresponding requested skill score. For example, the candidate request may comprise a requested skill of “Java Coding”, a requested skill score of 4.0 for “easy” difficulty level, a requested skill score of 3.5 for “medium” difficulty level, and a request skill score of 2.5 for “hard” difficulty level. The candidate request may comprise a plurality of requested skills, with each requested skill having a requested skill score corresponding to at least one difficulty level. In that respect, the candidate request may allow the user to control the quality and volume of candidates that will be returned from the candidate request, by enabling the user to request for candidates having specific requested skills, and filter those candidates based on the requested skill score. In various embodiments, the candidate request may also comprise a requested location, such as “Arizona”, “United States”, “Phoenix”, and/or any other suitable location.

In various embodiments, CCT 50 may also be configured to match the candidate request to the stored candidate resumes in screened candidate database 38. In that regard, CCT 50 may search screened candidate database 38 to determine the scored candidate resumes meeting the requirements of the candidate request. For example, in response to the candidate request comprising a requested skill of “Java” and a requested skill score of 3.0 for the “easy” difficulty level, a requested skill score of 3.5 for the “medium” difficulty level, and a requested skill score of 3.5 for the “hard” difficulty level, CCT 50 will only retrieve the scored candidate resumes comprising at least the parsed skill of “Java”, with difficulty scores corresponding to at least the above request. In various embodiments, CCT 50 may also at least partially match the requested location to a stored candidate resume by parsing the candidate identifying information to retrieve candidate location information (e.g., state, city, zip code, etc.).

In various embodiments, CCT 50 may also be configured to generate a matched candidate request list. The matched candidate request list may comprise each scored candidate resume matching the candidate request. CCT 50 may transmit the matched candidate request list to any suitable destination, such as, for example, employer terminal 55. CCT 50 may transmit the matched candidate request list as an email, text message, document attachment, and/or through any other suitable transmission and document type.

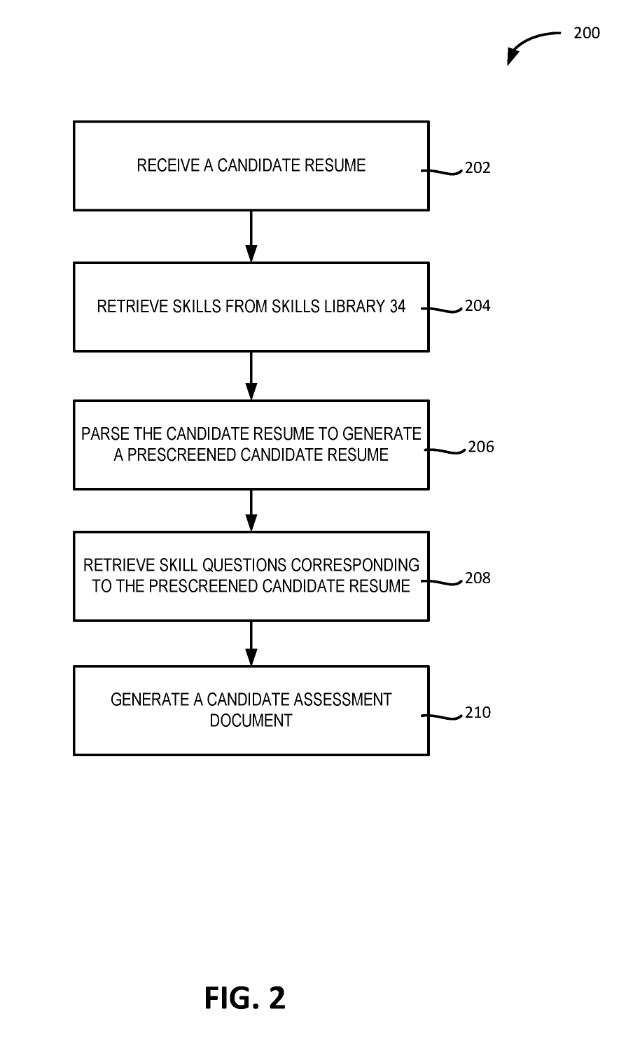

In various embodiments, and with reference to FIG. 2, and continued reference to FIG. 1, a method 200 for generating a candidate assessment document is disclosed. In various embodiments, method 200 may comprise receiving a candidate resume (Step 202). Screening controller 10 may receive the candidate resume from network 20. In various embodiments, screening controller 10 may receive the candidate resume from candidate terminal 25, via network 20. In various embodiments, the candidate resume may be transmitted in any suitable format, such as, for example, a word document, PDF, and/or via a Tillable website providing pre-established fields. In that regard, a candidate may submit the candidate resume in response to a job posting, resume collection, and/or the like. In various embodiments, screening controller 10 may also dynamically receive the candidate resume from network 20. For instance, screening controller 10 may communicate with network 20 using web crawlers, and/or the like, to retrieve candidate resumes. For example, screening controller 10 may search through LinkedIn.com®, Monster.com®, Indeed.com®, and/or through similar such job posting websites, via network 20, to retrieve candidate resumes. The web crawler may search candidate resumes to at least partially match the defined skills with key words in the candidate resume (and/or online profile). In that regard, the resume information matching the defined skill does not need to be organized into pre-established fields in order to be located by screening controller 10, via the web crawler.

In various embodiments, method 200 may comprise retrieving defined skills from skills library 34 (Step 204). Screening controller 10 may communicate with skills library 34 to retrieve the defined skills. In various embodiments, method 200 may comprise parsing the candidate resume to generate a prescreened candidate resume (Step 206). Screening controller 10 may parse the candidate resume to locate the candidate skills corresponding to the defined skills. Screening controller 10 may generate the prescreened candidate resume, comprising the candidate resume and the parsed skills. In that respect, and in various embodiments, screening controller 10 may generate the prescreened candidate resume to comprise metadata, tags, and/or the like indicating the parsed skills comprised in the candidate resume. For example, the prescreened candidate resume may be generated to comprise metadata indicating the parsed skill of “Java”. In various embodiments, the candidate resume may also be manually reviewed by a user in order to locate the candidate skills corresponding to the defined skills. The user may then input the candidate skills to generate the prescreened candidate resume comprising the parsed skills. Screening controller 10 may transmit the prescreened candidate resume to prescreened candidate database 32.

In various embodiments, method 200 may comprise retrieving skill questions corresponding to the prescreened candidate resume (Step 208). DAB 40, via assessment module 42, may retrieve the prescreened candidate resume from prescreened candidate database 32. In various embodiments, the skill questions may be input into skills question database 36 via user input, retrieval from a networked resource such as the internet, and/or through any other suitable method. The skill questions may be associated with the defined skill, the difficulty level, and the skill answer prior to input into skills question database 36. For example, a user may review the skill questions and assign the difficulty level to the skill question. DAB 40 may analyze the prescreened candidate resume to determine the parsed skills associated with it. DAB 40 may then communicate with skills question database 36 to retrieve skill questions corresponding to the parsed skill. In various embodiments, DAB 40 may retrieve a plurality of skill questions corresponding to the parsed skill. DAB 40 may also retrieve skill questions having varying difficulty levels. For example, skill questions may be tagged (using metadata and/or the like) to comprise a difficulty level (e.g., “easy”, “medium”, and “hard”; 100, 200, 300, 400, and 500; and/or any other desired difficulty level scale). DAB 40 may be configured to retrieve skill questions across each difficulty level (e.g., four skill questions from each difficulty level). In various embodiments, DAB 40 may also be configured to retrieve random skill questions corresponding to each parsed skill, such that each set of retrieved skill questions may be different than another set of retrieved skill questions for the same parsed skill.

In various embodiments, method 200 may comprise generating a candidate assessment document (Step 210). DAB 40, via assessment module 42, may generate the candidate assessment document to comprise the skill questions corresponding to the prescreened candidate resume. For example, wherein the prescreened candidate resume comprises the parsed skills of Javascript, HTML, and CSS, DAB 40 may generate the candidate assessment document to comprise skills questions corresponding to Javascript, HTML, and CSS. In various embodiments, DAB 40 may generate the candidate assessment document to comprise skill questions of varying difficulty levels (e.g., the candidate assessment document may comprise a plurality of “easy”, “medium”, and “hard” difficulty level Javascript skill questions; a plurality of “easy”, “medium”, and “hard” difficulty level HTML skill questions; and a plurality of “easy”, “medium”, and “hard” difficulty level CSS skill questions).

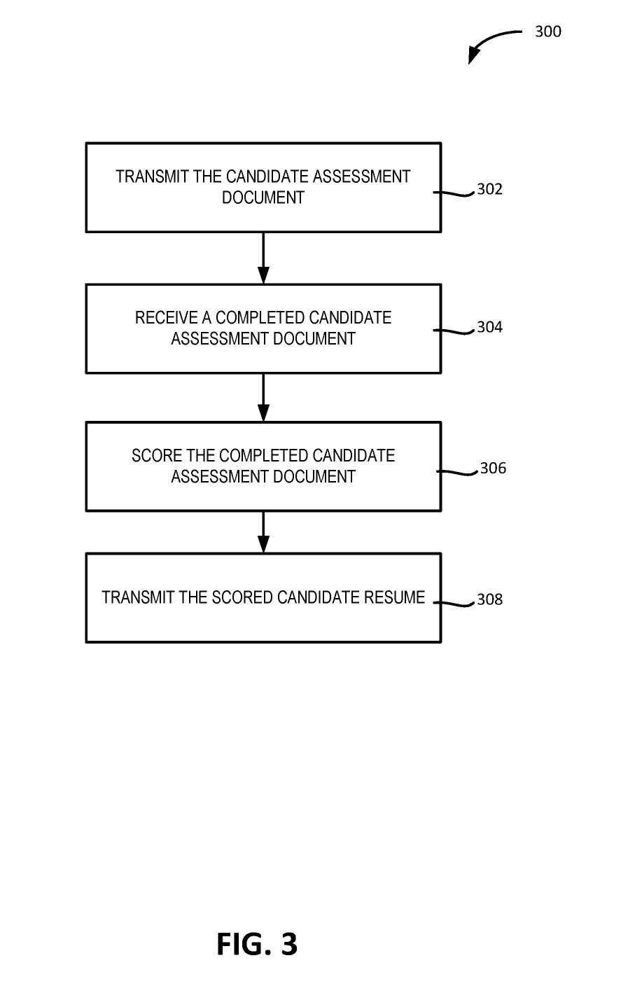

In various embodiments, and with reference to FIG. 3, and continued reference to FIG. 1, a method 300 for scoring a candidate assessment document is disclosed. In various embodiments, method 300 may comprise transmitting the candidate assessment document (Step 302). DAB 40, via interviewing module 44, may transmit the candidate assessment document to network 20. In various embodiments, the candidate assessment document may be transmitted from network 20 to candidate terminal 25 for candidate review and answer. In that regard, the skill questions in the candidate assessment document may be displayed on a user interface (such as a computer screen) of candidate terminal 25. The candidate may then provide answers to the skill questions, via input into candidate terminal 25, to generate a completed candidate assessment document. In various embodiments, candidate terminal 25 may comprise testing restrictions while the candidate answers the skill questions. For example, the testing restrictions may comprise a set time to answer each skill question (e.g., 5 minutes per a skill question, and/or the like), a block or restriction from accessing the internet from candidate terminal 25, and/or any other suitable testing restriction. The completed candidate assessment document may be transmitted, via candidate terminal 25, to network 20.

In various embodiments, the candidate assessment document may be retrieved from network 20 by a user to manually interview the candidate. The user may interview the candidate in person, via Skype®, and/or through any other method. The user may manually generate a completed candidate assessment document comprising the candidate's answers to the skill questions. In that respect, manually interviewing the candidate may allow the user to also include additional data in the completed candidate assessment document, such as, for example, communication skills, energy, composure and/or presence, and/or the like.

In various embodiments, method 300 may comprise receiving a completed candidate assessment document (Step 304). DAB 40 may receive the completed candidate assessment document from network 20. In various embodiments, method 300 may comprise scoring the completed candidate assessment document (Step 306). In various embodiments, DAB 40, via scoring module 46, may communicate with skills question database 36 to retrieve a skill answer associated with each corresponding skill question from the completed candidate assessment document. DAB 40 may parse the completed candidate assessment document, based on the skill answer, to determine a candidate score for each skill question. In that regard, DAB 40 may compare the candidate answer to the skill answer to determine the level of correctness in the answer. For example, and in various embodiments, DAB 40 may parse the candidate answer to search for keywords in the skill answer. For example, in response to the skill question comprising: “Explain the object oriented concept of encapsulation,” DAB 40 may parse the candidate answer to look for keywords such as “selective hiding”, “properties”, “methods”, “object”, “wall”, “protect code”, and/or other similar keywords. In various embodiments, in response to the skill question requesting the candidate to draft programming code (e.g., in Java, C#, etc.), DAB 40 may determine the candidate score by compiling the code, and parsing the compiled code to determine the accuracy of the compiled code. In various embodiments, the skill answer correlated to the programming skill question may comprise test cases (e.g., a plurality of code example answers to the skill question), and scoring module 46 may determine the candidate score by parsing the candidate answer to look for keywords from the test cases in the skill answers.

In various embodiments, the score may comprise a point value, such as 1, 2, 3, 4, or 5, indicating the correctness of the candidate answer. DAB 40 may score each skill question across each difficulty level, and compile and average the scores for each difficulty level. DAB 40 may then generate a candidate score for each defined skill, across each difficulty level. For example, a candidate score for the defined skill of “Java Coding” may comprise a “3.4” for “easy”, a “4.0” for “medium”, and a “2.7” for “hard” difficulty levels.

In various embodiments, the completed candidate assessment document may also be manually scored. For example, the skill questions may be reviewed by a user and given a score. Manually scoring the completed candidate assessment document may enable the scoring of skill questions that are difficult to score by a computer based system, such as, for example, skill questions based on drafting programming code, and/or the like. The scores may then be averaged, via DAB 40, to generate the candidate score. DAB 40 may generate a scored candidate resume comprising the candidate identifying information, the parsed skills, and the candidate skill. In various embodiments, method 300 may comprise transmitting the scored candidate resume (Step 308). DAB 40 may transmit the scored candidate resume to screened candidate database 38 for storage.

In various embodiments, CCT 50 may also retrieve scored candidate resumes for employee review. In that regard, CCT 50 may retrieve scored candidate resumes and generate an employee development plan. The employee development plan may allow a user to identify areas of improvement for candidates after the candidate has been hired into a job opening. For example, the employee development plan may indicate that the candidate excels in “Java Coding” but is poor in another defined skill, such as “CSS”. CCT 50 may generate the employee development plan and transmit the employee development plan to employer terminal 55.

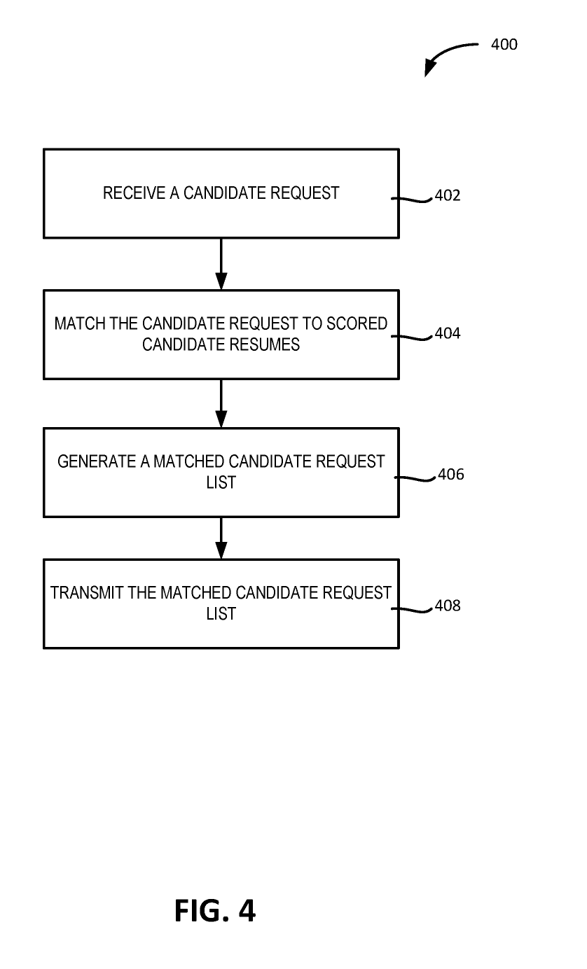

In various embodiments, and with reference to FIG. 4, and continued reference to FIG. 1, a method 400 for matching a candidate request with a screened candidate is disclosed. Method 400 may enable a user, employer, recruiter, and/or the like to search and identify candidates for a job opening, regardless of whether the candidate initially applied for that job. In various embodiments, method 400 may comprise receiving a candidate request (Step 402). CCT 50 may receive the candidate request from employer terminal 55. In that regard, a user may submit the candidate request from employer terminal 55.

In various embodiments, method 400 may comprise matching the candidate request to the scored candidate resumes (Step 404). CCT 50 may communicate with screened candidate database 38 to match the candidate request to the scored candidate resumes. In that regard, CCT 50 may search screened candidate database 38 to determine the scored candidate resumes meeting the requirements of the candidate request. For example, in response to the candidate request comprising a requested skill of “Java” and a requested “easy” difficulty score of above 3.0, a requested “medium” difficulty score of above 3.5, and a requested “hard” difficulty score of above 3.5, CCT 50 will only retrieve the scored candidate resumes comprising at least the parsed skill of “Java”, with difficulty scores corresponding to the above request. In various embodiments, CCT 50 may also at least partially match a requested location of the candidate request to a stored candidate resume by parsing the candidate identifying information to retrieve candidate location information (e.g., state, city, zip code, etc.).

In various embodiments, method 400 may comprise generating a matched candidate request list (Step 406). CCT 50 may generate the matched candidate request list to comprise the scored candidate resumes matched in Step 404. In various embodiments, method 400 may comprise transmitting the matched candidate request list (Step 408). CCT 50 may transmit the matched candidate request list to any suitable destination, such as, for example, employer terminal 55. CCT 50 may transmit the matched candidate request list as an email, text message, document attachment, and/or through any other suitable transmission and document type.

In various embodiments, the system and method may include alerting a subscriber when their computer is offline. With brief reference to FIG. 1, system 100 may include generating customized information and alerting a remote subscriber that the information can be accessed from their computer (e.g., candidate terminal 25 and/or employer terminal 55). The alerts are generated by filtering received information, building information alerts and formatting the alerts into data blocks based upon subscriber preference information, via CCT 50, for example. The data blocks are transmitted to the subscriber's wireless device, which, when connected to the computer, causes the computer to auto-launch an application to display the information alert and provide access to more detailed information about the information alert. More particularly, the method may comprise providing a viewer application to a subscriber for installation on the remote subscriber computer; receiving information at a transmission server sent from a data source over the Internet, the transmission server comprising a microprocessor and a memory that stores the remote subscriber's preferences for information format, destination address, specified information, and transmission schedule, wherein the microprocessor filters the received information by comparing the received information to the specified information; generates an information alert from the filtered information that contains a name, a price and a universal resource locator (URL), which specifies the location of the data source; formats the information alert into data blocks according to said information format; and transmits the formatted information alert over a wireless communication channel to a wireless device associated with a subscriber based upon the destination address and transmission schedule, wherein the alert activates the application to cause the information alert to display on the remote subscriber computer and to enable connection via the URL to the data source over the Internet when the wireless device is locally connected to the remote subscriber computer and the remote subscriber computer comes online.

In various embodiments, the system and method may include a graphical user interface for dynamically relocating/rescaling obscured textual information of an underlying window to become automatically viewable to the user. By permitting textual information to be dynamically relocated based on an overlap condition, the computer's ability to display information is improved. More particularly, the method for dynamically relocating textual information within an underlying window displayed in a graphical user interface may comprise displaying a first window containing textual information in a first format within a graphical user interface on a computer screen (e.g., via candidate terminal 25 and/or employer terminal 55); displaying a second window within the graphical user interface; constantly monitoring the boundaries of the first window and the second window to detect an overlap condition where the second window overlaps the first window such that the textual information in the first window is obscured from a user's view; determining the textual information would not be completely viewable if relocated to an unobstructed portion of the first window; calculating a first measure of the area of the first window and a second measure of the area of the unobstructed portion of the first window; calculating a scaling factor which is proportional to the difference between the first measure and the second measure; scaling the textual information based upon the scaling factor; automatically relocating the scaled textual information, by a processor, to the unobscured portion of the first window in a second format during an overlap condition so that the entire scaled textual information is viewable on the computer screen by the user; and automatically returning the relocated scaled textual information, by the processor, to the first format within the first window when the overlap condition no longer exists.

In various embodiments, the system may also include isolating and removing malicious code from electronic messages (e.g., email) to prevent a computer (e.g., candidate terminal 25 and/or employer terminal 55) from being compromised, for example by being infected with a computer virus. The system may scan, via CCT 50 for example, electronic communications for malicious computer code and clean the electronic communication before it may initiate malicious acts. The system operates by physically isolating a received electronic communication in a “quarantine” sector of the computer memory. A quarantine sector is a memory sector created by the computer's operating system such that files stored in that sector are not permitted to act on files outside that sector. When a communication containing malicious code is stored in the quarantine sector, the data contained within the communication is compared to malicious code-indicative patterns stored within a signature database. The presence of a particular malicious code-indicative pattern indicates the nature of the malicious code. The signature database further includes code markers that represent the beginning and end points of the malicious code. The malicious code is then extracted from malicious code-containing communication. An extraction routine is run by a file parsing component of the processing unit. The file parsing routine performs the following operations: scan the communication for the identified beginning malicious code marker; flag each scanned byte between the beginning marker and the successive end malicious code marker; continue scanning until no further beginning malicious code marker is found; and create a new data file by sequentially copying all non-flagged data bytes into the new file, which thus forms a sanitized communication file. The new, sanitized communication is transferred to a non-quarantine sector of the computer memory. Subsequently, all data on the quarantine sector is erased. More particularly, the system includes a method for protecting a computer from an electronic communication containing malicious code by receiving an electronic communication containing malicious code in a computer with a memory having a boot sector, a quarantine sector and a non-quarantine sector; storing the communication in the quarantine sector of the memory of the computer, wherein the quarantine sector is isolated from the boot and the non-quarantine sector in the computer memory, where code in the quarantine sector is prevented from performing write actions on other memory sectors; extracting, via file parsing, the malicious code from the electronic communication to create a sanitized electronic communication, wherein the extracting comprises scanning the communication for an identified beginning malicious code marker, flagging each scanned byte between the beginning marker and a successive end malicious code marker, continuing scanning until no further beginning malicious code marker is found, and creating a new data file by sequentially copying all non-flagged data bytes into a new file that forms a sanitized communication file; transferring the sanitized electronic communication to the non-quarantine sector of the memory; and deleting all data remaining in the quarantine sector.

In various embodiments, system 100 may also address the problem of retaining control over customers during affiliate purchase transactions, using a system for co-marketing the “look and feel” of the host web page with the product-related content information of the advertising merchant's web page. System 100 can be operated by a third-party outsource provider, who acts as a broker between multiple hosts and merchants. Prior to implementation, a host places links to a merchant's webpage on the host's web page. The links are associated with product-related content on the merchant's web page. Additionally, the outsource provider system stores the “look and feel” information from each host's web pages in a computer data store, which is coupled to a computer server. The “look and feel” information includes visually perceptible elements such as logos, colors, page layout, navigation system, frames, mouse-over effects or other elements that are consistent through some or all of each host's respective web pages. A customer who clicks on an advertising link is not transported from the host web page to the merchant's web page, but instead is re-directed to a composite web page that combines product information associated with the selected item and visually perceptible elements of the host web page. The outsource provider's server responds by first identifying the host web page where the link has been selected and retrieving the corresponding stored “look and feel” information. The server constructs a composite web page using the retrieved “look and feel” information of the host web page, with the product-related content embedded within it, so that the composite web page is visually perceived by the customer as associated with the host web page. The server then transmits and presents this composite web page to the customer so that she effectively remains on the host web page to purchase the item without being redirected to the third party merchant affiliate. Because such composite pages are visually perceived by the customer as associated with the host web page, they give the customer the impression that she is viewing pages served by the host. Further, the customer is able to purchase the item without being redirected to the third party merchant affiliate, thus allowing the host to retain control over the customer. This system enables the host to receive the same advertising revenue streams as before but without the loss of visitor traffic and potential customers. More particularly, the system may be useful in an outsource provider serving web pages offering commercial opportunities. The computer store containing data, for each of a plurality of first web pages, defining a plurality of visually perceptible elements, which visually perceptible elements correspond to the plurality of first web pages; wherein each of the first web pages belongs to one of a plurality of web page owners; wherein each of the first web pages displays at least one active link associated with a commerce object associated with a buying opportunity of a selected one of a plurality of merchants; and wherein the selected merchant, the outsource provider, and the owner of the first web page displaying the associated link are each third parties with respect to one other; a computer server at the outsource provider, which computer server is coupled to the computer store and programmed to: receive from the web browser of a computer user a signal indicating activation of one of the links displayed by one of the first web pages; automatically identify as the source page the one of the first web pages on which the link has been activated; in response to identification of the source page, automatically retrieve the stored data corresponding to the source page; and using the data retrieved, automatically generate and transmit to the web browser a second web page that displays: information associated with the commerce object associated with the link that has been activated, and the plurality of visually perceptible elements visually corresponding to the source page.

As used herein, “satisfy”, “meet”, “match”, “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Terms and phrases similar to “associate” and/or “associating” may include tagging, flagging, correlating, using a look-up table or any other method or system for indicating or creating a relationship between elements, such as, for example, (i) a transaction account and (ii) an item (e.g., offer, reward, discount) and/or digital channel. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input and/or any other method known in the art.

The phrases consumer, customer, user, account holder, account affiliate, cardmember or the like shall include any person, entity, business, government organization, business, software, hardware, machine associated with a transaction account, buys merchant offerings offered by one or more merchants using the account and/or who is legally designated for performing transactions on the account, regardless of whether a physical card is associated with the account. For example, the cardmember may include a transaction account owner, a transaction account user, an account affiliate, a child account user, a subsidiary account user, a beneficiary of an account, a custodian of an account, and/or any other person or entity affiliated or associated with a transaction account.

Phrases and terms similar to a “party” may include any individual, consumer, customer, group, business, organization, government entity, transaction account issuer or processor (e.g., credit, charge, etc.), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

The system may include or interface with any of the foregoing accounts, devices, and/or a transponder and reader (e.g. RFID reader) in RF communication with the transponder (which may include a fob), or communications between an initiator and a target enabled by near field communications (NFC). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc. Furthermore, a device or financial transaction instrument may have electronic and communications functionality enabled, for example, by: a network of electronic circuitry that is printed or otherwise incorporated onto or within the transaction instrument (and typically referred to as a “smart card”); a fob having a transponder and an RFID reader; and/or near field communication (NFC) technologies. For more information regarding NFC, refer to the following specifications all of which are incorporated by reference herein: ISO/IEC 18092/ECMA-340, Near Field Communication Interface and Protocol-1 (NFCIP-1); ISO/IEC 21481/ECMA-352, Near Field Communication Interface and Protocol-2 (NFCIP-2); and EMV 4.2 available at http://www.emvco.com/default.aspx.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16 bit integers.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

A record of charge (or “ROC”) may comprise any transaction or transaction data. The ROC may be a unique identifier associated with a transaction. A transaction may, in various embodiments, be performed by a one or more members using a transaction account, such as a transaction account associated with a gift card, a debit card, a credit card, and the like. A ROC may, in addition, contain details such as location, merchant name or identifier, transaction amount, transaction date, account number, account security pin or code, account expiry date, and the like for the transaction.

Distributed computing cluster may be, for example, a Hadoop® cluster configured to process and store big data sets with some of nodes comprising a distributed storage system and some of nodes comprising a distributed processing system. In that regard, distributed computing cluster may be configured to support a Hadoop® distributed file system (HDFS) as specified by the Apache Software Foundation at http://hadoop.apache.org/docs/. For more information on big data management systems, see U.S. Ser. No. 14/944,902 titled INTEGRATED BIG DATA INTERFACE FOR MULTIPLE STORAGE TYPES and filed on Nov. 18, 2015; U.S. Ser. No. 14/944,979 titled SYSTEM AND METHOD FOR READING AND WRITING TO BIG DATA STORAGE FORMATS and filed on Nov. 18, 2015; U.S. Ser. No. 14/945,032 titled SYSTEM AND METHOD FOR CREATING, TRACKING, AND MAINTAINING BIG DATA USE CASES and filed on Nov. 18, 2015; U.S. Ser. No. 14/944,849 titled SYSTEM AND METHOD FOR AUTOMATICALLY CAPTURING AND RECORDING LINEAGE DATA FOR BIG DATA RECORDS and filed on Nov. 18, 2015; U.S. Ser. No. 14/944,898 titled SYSTEMS AND METHODS FOR TRACKING SENSITIVE DATA IN A BIG DATA ENVIRONMENT and filed on Nov. 18, 2015; and U.S. Ser. No. 14/944,961 titled SYSTEM AND METHOD TRANSFORMING SOURCE DATA INTO OUTPUT DATA IN BIG DATA ENVIRONMENTS and filed on Nov. 18, 2015, the contents of each of which are herein incorporated by reference in their entirety.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., Facebook, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE® .pdf document, etc.), an “ebook,” an “emagazine,” an application or microapplication (as described herein), an SMS or other type of text message, an email, Facebook® message, Twitter® tweet and/or message, MMS, and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

In various embodiments, the methods described herein are implemented using the various particular machines described herein. The methods described herein may be implemented using the herein particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system may also include a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEB SPHERE, WEB LOGIC, JBOSS, etc.). In various embodiments, the server may include web servers (e.g. APACHE, IIS, GWS, SUN JAVA® SYSTEM WEB SERVER).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. A web-client may run MICROSOFT® INTERNET EXPLORER®, MOZILLA® FIREFOX®, GOOGLE® CHROME®, APPLE® Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., WINDOWS® OS, OS2, UNIX® OS, LINUX® OS, SOLARIS®, MacOS, and/or the like) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® Operating System, APPLE® IOS®, a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein.

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing.

As used herein, “transmit” may include sending electronic data from one system component to another over a network connection. Additionally, as used herein, “data” may include encompassing information such as commands, queries, files, data for storage, and the like in digital or any other form.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, blockchain, or object-oriented structure and/or any other database configurations. The databases may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure.

The blockchain structure may include a distributed database that maintains a growing list of data records. The blockchain may provide enhanced security because each block may hold individual transactions and the results of any blockchain executables. Each block may contain a timestamp and a link to a previous block. Blocks may be linked because each block may include the hash of the prior block in the blockchain. The linked blocks form a chain, with only one successor block allowed to link to one other predecessor block.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may then be designated as a key field in a plurality of related data tables and the data tables may be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with the system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with system, by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the user at the standalone device, the appropriate option for the action to be taken. The system may contemplate a data storage arrangement wherein the header or trailer, or header or trailer history, of the data is stored on the system, device, or transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PM, GPG (GnuPG), and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® web server software, a MICROSOFT® SQL Server database system, and a MICROSOFT® Commerce Server. Additionally, components such as Access or MICROSOFT® SQL Server, ORACLE®, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request including a URL and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEBSPHERE MQTM (formerly MQSeries) by IBM®, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. Cryptography and network security methods are well known in the art, and are covered in many standard texts.

As used herein, the term “end user”, “consumer”, “customer”, “cardmember”, “business”, “merchant”, or “financial institution” may be used interchangeably with each other, and each shall mean any person, entity, government organization, business, machine, hardware, and/or software. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein.

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet®, Veriphone®, Discover Card®, PayPal®, ApplePay®, GooglePay®, private networks (e.g., department store networks), and/or any other transaction networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is intended to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method, comprising:
receiving, by a processor of a computer based system, a candidate resume, wherein the candidate resume comprises candidate identifying information and candidate skills;
retrieving, by the processor, defined skills from a skills library;
determining, by the processor, a parsed skill by parsing the candidate resume to locate the candidate skills at least partially matching the defined skills;
retrieving, by the processor and via a skill questions database, skill questions corresponding to the parsed skills; and
generating, by the processor, a candidate assessment document comprising the candidate identifying information and the skill questions corresponding to the parsed skills.

2. The method of claim 1, further comprising receiving, by the processor, a completed candidate assessment document, wherein the completed candidate assessment document comprises candidate answers to the candidate assessment document.

3. The method of claim 2, further comprising:
retrieving, by the processor and via the skill questions database, skill answers corresponding to the skill questions;
formulating, by the processor, a candidate score by comparing the candidate answers to the skill answers; and
generating, by the processor, a scored candidate resume comprising the candidate identifying information, the parsed skills, and the candidate score.

4. The method of claim 3, further comprising:
receiving, by the processor, a candidate request, wherein the candidate request comprises requested skills and a requested skill score;
matching, by the processor, the candidate request to a scored candidate resume by comparing the requested skills to the parsed skills, and the requested skill score to the candidate score; and
generating, by the processor, a matched candidate request list comprising the scored candidate resumes matched with the candidate request.

5. The method of claim 1, wherein the skill questions further comprise a difficulty level.

6. The method of claim 5, wherein retrieving the skill questions further comprises retrieving skill questions having varying difficulty levels.

7. The method of claim 1, wherein the candidate resume is received by the processor in response to web crawling on the internet.

8. A system comprising:
a processor,
a tangible, non-transitory memory configured to communicate with the processor,
the tangible, non-transitory memory having instructions stored thereon that, in response to execution by the processor, cause the processor to perform operations comprising:
receiving, by the processor, a candidate resume, wherein the candidate resume comprises candidate identifying information and candidate skills;
retrieving, by the processor, defined skills from a skills library;
determining, by the processor, a parsed skill by parsing the candidate resume to locate the candidate skills at least partially matching the defined skills;
retrieving, by the processor and via a skill questions database, skill questions corresponding to the parsed skills; and
generating, by the processor, a candidate assessment document comprising the candidate identifying information and the skill questions corresponding to the parsed skills.

9. The system of claim 8, further comprising receiving, by the processor, a completed candidate assessment document, wherein the completed candidate assessment document comprises candidate answers to the candidate assessment document.

10. The system of claim 9, further comprising:
retrieving, by the processor and via the skill questions database, skill answers corresponding to the skill questions;
formulating, by the processor, a candidate score by comparing the candidate answers to the skill answers; and
generating, by the processor, a scored candidate resume comprising the candidate identifying information, the parsed skills, and the candidate score.

11. The system of claim 10, further comprising:
receiving, by the processor, a candidate request, wherein the candidate request comprises requested skills and a requested skill score;
matching, by the processor, the candidate request to a scored candidate resume by comparing the requested skills to the parsed skills, and the requested skill score to the candidate score; and
generating, by the processor, a matched candidate request list comprising the scored candidate resumes matched with the candidate request.

12. The system of claim 7, wherein the skill questions further comprise a difficulty level.

13. The system of claim 12, wherein retrieving the skill questions further comprises retrieving skill questions having varying difficulty levels.

14. The system of claim 7, wherein the candidate resume is received by the processor in response to web crawling on the internet.

15. An article of manufacture including a non-transitory, tangible computer readable storage medium having instructions stored thereon that, in response to execution by a computer based system, cause the computer based system to perform operations comprising:
receiving a candidate resume, wherein the candidate resume comprises candidate identifying information and candidate skills;
retrieving defined skills from a skills library;
determining a parsed skill by parsing the candidate resume to locate the candidate skills at least partially matching the defined skills;
retrieving skill questions corresponding to the parsed skills from a skills question database; and
generating a candidate assessment document comprising the candidate identifying information and the skill questions corresponding to the parsed skills.

16. The article of manufacture of claim 15, further comprising receiving, by the processor, a completed candidate assessment document, wherein the completed candidate assessment document comprises candidate answers to the candidate assessment document.

17. The article of manufacture of claim 16, further comprising:
retrieving skill answers corresponding to the skill questions from the skill questions database;
formulating a candidate score by comparing the candidate answers to the skill answers; and
generating a scored candidate resume comprising the candidate identifying information, the parsed skills, and the candidate score.

18. The article of manufacture of claim 17, further comprising:
receiving a candidate request, wherein the candidate request comprises requested skills and a requested skill score;
matching the candidate request to a scored candidate resume by comparing the requested skills to the parsed skills, and the requested skill score to the candidate score; and
generating a matched candidate request list comprising the scored candidate resumes matched with the candidate request.

19. The article of manufacture of claim 15, wherein the skill questions further comprise a difficulty level, and wherein retrieving the skill questions further comprises retrieving skill questions having varying difficulty levels.

20. The article of manufacture of claim 15, wherein the candidate resume is received in response to web crawling on the internet.
